(19) United States
(12) Patent Application Publication
(10) Pub. No.: US 2025/0286435 A1
(43) Pub. Date: Sep. 11, 2025

(54) DECENTRALIZED RENEWABLE POWER GENERATION AND METHODS FOR UNIVERSAL BASIC INCOME

(71) Applicant: Malek SHAYAN, Reno, NV (US)

(72) Inventor: Malek SHAYAN, Reno, NV (US)

(21) Appl. No.: 18/634,645

(22) Filed: Apr. 12, 2024

Related U.S. Application Data
(60) Provisional application No. 63/562,945, filed on Mar. 8, 2024.

(51) Int. Cl. H02K 7/18; H02K 21/14

(52) U.S. Cl. CPC H02K 7/1823; H02K 21/14

(57) ABSTRACT

A device for generating power may include a mobius magnet array. A device may include an external magnet array configured to generate a magnetic field within the device, wherein the magnetic field exerts a rotational force on the mobius magnet array. A device may include a shaft connected to the mobius magnet array, the shaft configured to rotate when the magnetic field exerts a force on the mobius magnet array. A device may include an alternator connected to the shaft, the alternator configured to convert the rotational motion of the shaft into electrical power.

### BACKGROUND

Most viable commercial electric power generation systems today share common and limiting characteristics. Coal, liquid combustible, and nuclear power generation systems require heat or chemical reactions and produce pollutants as a byproduct. These systems are not necessarily renewable or clean. The electrical output of these systems is heavily centralized and the distribution infrastructure (transmission poles) is unreliable, susceptible to failure, and expensive to maintain. So called alternative clean energy systems such as solar and wind require limited elements and are not viable in all environmental locations. They also struggle to meet on-demand energy needs without supplemental battery storage systems.

With the exception of solar energy, today's commercial power generation systems convert mechanical energy into electrical output. A nuclear power plant for example is an expensive and dangerous steam engine that creates rotational inertia and converts that mechanical energy into electricity. A gas powered generator utilizes a combustion motor to mechanically rotate a shaft to produce an electrical output. In its simplest form mechanical rotation about a point can be converted into electrical energy. The rotating inertia mechanism or mechanical energy produced by these systems are commonly called prime movers. Prime movers convert the primary source into mechanical energy that create electrical energy when combined with some kind of alternator or magnetic/electric induction machine. These existing systems are utilizing limited energy sources to power their prime movers to generate mechanical rotation. Re-thinking the source of mechanical rotation is the novelty of the described design in this patent.

### SUMMARY

In some aspects, the techniques described herein relate to a device for generating power, the device including: a mobius magnet array including: a surface in the form of a mobius strip; and a plurality of magnets disposed on the surface; an external magnet array configured to generate a magnetic field within the device, wherein the magnetic field exerts a rotational force on the mobius magnet array; a shaft connected to the mobius magnet array, the shaft configured to rotate when the magnetic field exerts a force on the mobius magnet array;

and an alternator connected to the shaft, the alternator configured to convert the rotational motion of the shaft into electrical power.

In some aspects, the techniques described herein relate to a method for generating power, the method including: providing a mobius magnet array including: a surface in the form of a mobius strip; and a plurality of magnets disposed on the surface; exposing the mobius magnet array to an external magnetic field; rotating the mobius magnet array in response to the external magnetic field; rotating a shaft connected to the mobius magnet array; and converting the rotational motion of the shaft into electrical power.

In some embodiments, the method further includes: directing at least a portion of the electrical power to hardware; providing computational power, via the hardware, to a blockchain network; and validating a blockchain within the blockchain network.

In this outlined design the mechanical rotation needed to output electricity utilizes permanent magnets placed in a fixed array on a mobius strip or band (twisted cylinder) to force helical or rotational direction of a shaft. The positive and negative poles of permanent magnets when placed in a specific array on a mobius band surrounded by additional magnets can produce a unidirectional push-pull force and rotate a shaft. The unique profile of a mobius strip can align the push-pull forces of individual magnets to create the angular velocity of the shaft. This rotation is used to create multi-phase electricity when integrated with a traditional rotating electric generator. The output of this permanent magnet array can create enough electricity to power much larger electro-magnetic arrays on similar mobius strips rotating larger shafts for increased output.

This architecture can be scalable to any size from small consumer electronic devices to warehouse sized power generators supplying clusters of neighborhoods. The rotating magnet mobius array can be buried underground as it would require little maintenance. This mechanical energy source is permanent, clean, unlimited, and no heat or burning is required. This motion would require little to no maintenance except for lubrication of bearings and shafts where rotation is occurring. Power generation can become decentralized and can be isolated to an electronic device, vehicle, building or home. No charging of battery or energy storage would be required. Energy consumption would be on demand. The need for large public infrastructure would become obsolete and power generation and distribution would become significantly more robust as the grid becomes decentralized. Power generation exists at the point location where the consumer needs it.

When power generation becomes decentralized and unlimited in supply the excess power available when the device, vehicle or home is not in use can be utilized by computer hardware like CPUs, graphical processors (GPUs), solid state storage devices (SSD), and radio antennas. Devices, vehicles, and homes can utilize the excess electrical energy to “mine” and “validate” blockchain based cryptocurrencies to earn monetary rewards. Similar to corporate server farms providing cloud computer services, a home or building becomes a competitive and reliable node in the network with resilient power backup redundancy.

Every cell phone, vehicle, and smart home device equipped with unlimited power supply and computational hardware can act as a dynamic validation node for large cryptocurrency networks to generate universal basic income. Blockchain based cryptocurrencies like Bitcoin and others would benefit from a vast and distributed network of computational power. Proof of work, proof of capacity, proof of stake cryptocurrencies reward participants with currency when contributing computational and electrical power to secure and validate their networks. Examples of blockchain mining include those in U.S. Pat. No. 11,196,566, which describes validating and mining of blockchain network with input from or participation of a third party, US Patent Pub. No. 2024/0005350 A1, and U.S. Pat. No. 10,771,524, which describe using hardware computational resource sharing in blockchains networks. Each of these references are hereby incorporated by reference in their entireties.

### BRIEF DESCRIPTION OF THE DRAWINGS

The detailed description is set forth with reference to the accompanying figures. The use of the same numbers in different figures indicates similar or identical items.

For this discussion, the devices and systems illustrated in the figures are shown as having a multiplicity of components. Various implementations of devices and/or systems, as described herein, may include fewer components, and remain within the scope of the disclosure. Alternatively, other implementations of devices and/or systems may include additional components, or various combinations of the described components, and remain within the scope of the disclosure.

FIG. 1 depicts a schematic view of a power generation system.

FIG. 2 depicts a schematic view of a steam turbine prime mover.

FIG. 3 depicts a schematic view of a wind powered turbine prime mover.

FIG. 4 depicts a schematic view of a cylinder and a mobius strip.

FIG. 5 shows a schematic view of a mobius magnet array.

FIG. 6A shows a schematic view of a device for generating power.

FIG. 6B shows a schematic view of a device for generating power connected to a battery storage system.

FIG. 7 shows a schematic view of a device for generating power.

FIG. 8A shows a schematic view of a power generation system.

FIG. 8B shows a schematic view of a system for generating power including a battery storage system.

FIG. 9A shows a schematic view of a system for powering a home.

FIG. 9B shows a schematic view of a system for powering a home with various power sources.

FIG. 9C shows a schematic view of a system for powering a home with various power sources.

FIG. 9D shows a schematic view of a system for powering a home with various power sources.

FIG. 10 shows a variety of forms that a power generation system can be implemented into

### DETAILED DESCRIPTION

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following detailed description is directed to certain specific embodiments of the development. Reference in this specification to “one embodiment,” “an embodiment,” or “in some embodiments” means that a particular feature, structure, or characteristic described in connection with the embodiment is included in at least one embodiment of the disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Furthermore, embodiments of the development may include several novel features, no single one of which is solely responsible for its desirable attributes or which is essential to practicing any particular embodiment described herein.

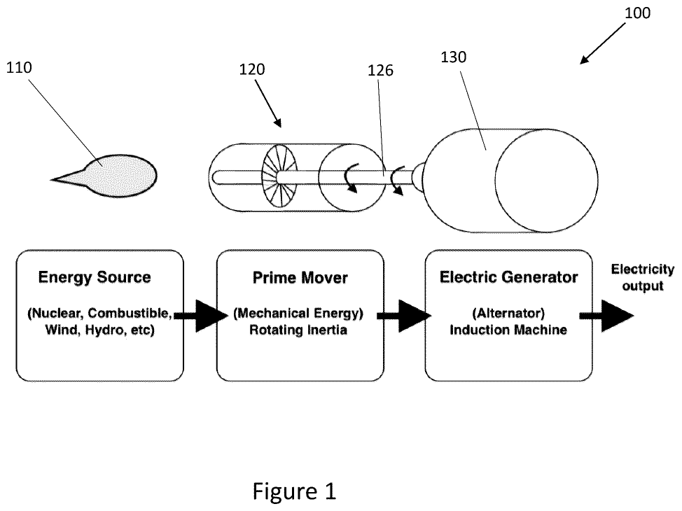

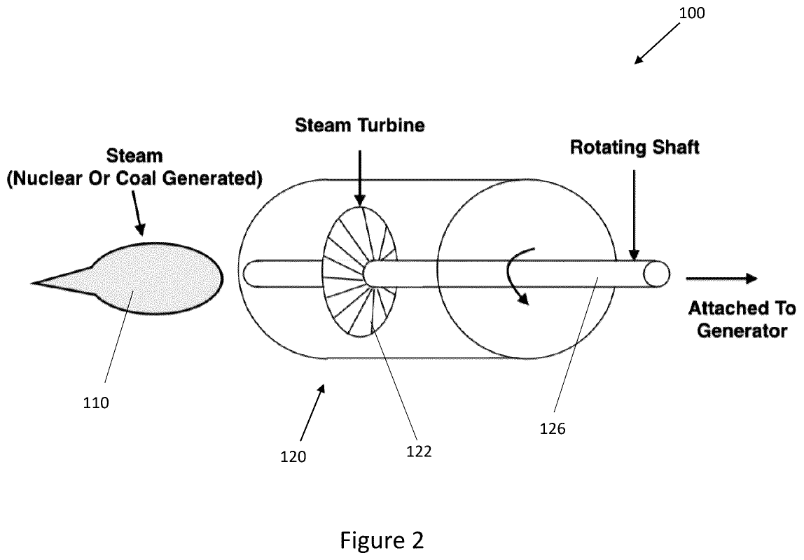

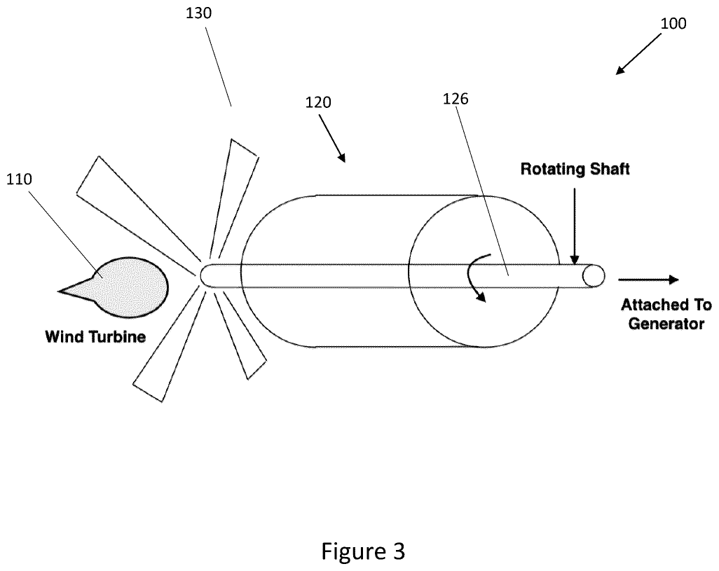

FIGS. 1-3 depict various devices commonly used for generating power by means of a prime mover. FIG. 1 depicts a schematic view of a power generation system 100. An energy source 110, such as nuclear power, a combustible fuel, wind, hydro, etc. Energy from the energy source 110 is provided to a prime mover 120 and the energy is converted into mechanical rotational movement and which in turn causes a shaft 126 of the prime mover to rotate. As seen in FIG. 1, the shaft 126 of the prime mover 120 is connected to an alternator 130 or generator. The alternator 130 is configured to convert the mechanical energy provided by the rotational movement of the shaft 126 into electrical power. The alternator 130 is then configured to transmit electrical power to a desired location. FIG. 2 depicts a schematic view of a power generation system 100 similar to FIG. 1. In FIG. 2, the energy source 110 is steam, typically high pressure steam. The steam can be produced by means of nuclear power or by means of burning coal. The steam is then forced into a steam turbine 112 which expands the steam and converts the energy received from the steam into mechanical energy which causes the shaft 126 to rotate. The shaft 126 is connected to a generator or alternator which converts the rotational motion of the shaft into electrical power. FIG. 3 shows a schematic view of a power generation system similar to FIGS. 1 and 2. In FIG. 3, the energy source 110 is wind. The wind causes rotation of blades 114 or other similar object that is connected to a shaft 126. The rotation of the blades 114 and causes rotation of the shaft 126 similar to the methods described above. The shaft 126 is connected to a generator or alternator which converts the rotational motion of the shaft into electrical power.

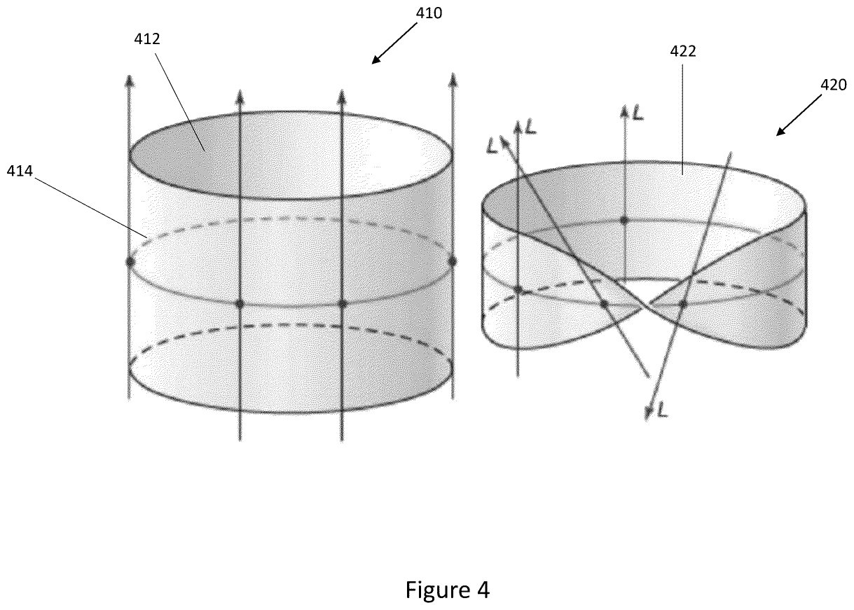

FIG. 4 shows a cylindrical band 410 and a mobius strip 420. A mobius strip or mobius as used herein refers to a continuous, one-side surface form by twisting one end of a rectangular strip through 180° about the longitudinal axis of the strip and attaching this end to the other. As seen in FIG. 4, a cylinder 410 has a first surface 412 and a second surface 414 which form the cylinder 410. The mobius strip 420 differs from the cylinder 410 in that the mobius strip 420 has a single continuous surface 422.

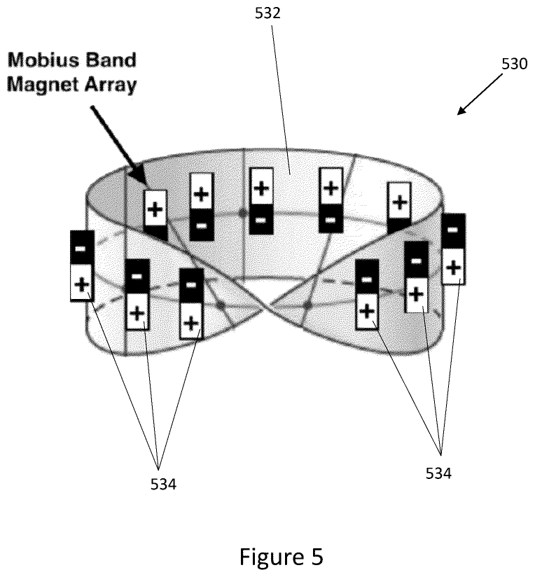

FIG. 5 shows a schematic view of a mobius magnet array 530. The mobius magnet array 530 includes a surface 532 and a plurality of magnets 534. The surface 532 is formed as a mobius strip. The magnets 534 are disposed across the surface 532. In some embodiments, the magnets 534 may be permanent magnets or electromagnets. In some embodiments, the magnets 534 are formed of a ferromagnetic material, such as, but not limited to, iron, nickel, cobalt, or combinations of the aforementioned materials. As seen in FIG. 5, the magnets 534 may be disposed along the surface 532 of the mobius strip such that magnets 534 are oriented consistently relative to the surface profile of the mobius strip. Such an orientation rotates the direction of the magnetic poles of each magnet 534 as the surface 532 of the mobius strip also rotates. This orientation of magnets 534 beneficially propels helical or rotational motion of the mobius strip when exposed to an external magnetic field. In some embodiments, the magnets 534 are disposed on the surface 532 of the mobius strip in a spatially rotating pattern, such that the magnets 534 form an Halbach array. As used herein, a Halbach array refers to a special arrangement of magnets that augments the magnetic field on one side of the array while cancelling the field to near zero on the other side. A Halbach array may take the form of a variety of shapes including, but not limited to, a linear array of magnets, a variable linear array of magnets, or a cylinder.

Orienting the magnets in this orientation beneficially augments the magnetic field generated by the magnets 534 on a first side of the magnet array formed by the magnets 534, while substantially canceling the magnetic field generated by the magnet array on a second side of the magnet array. This orientation of magnets 534 beneficially propels helical or rotational motion of the mobius strip when exposed to an external magnetic field.

In some embodiments, the surface 532 is formed of magnetic materials, such as ferromagnetic materials. In some embodiments, the surface 532 is formed of a Halbach array strip or Halbach array cylinder which is shaped into mobius band or strip. In some embodiments, the magnetic material of the surface 532 is magnetized. In some embodiments, the polarity of the magnetic surface is programmed to form a Halbach array.

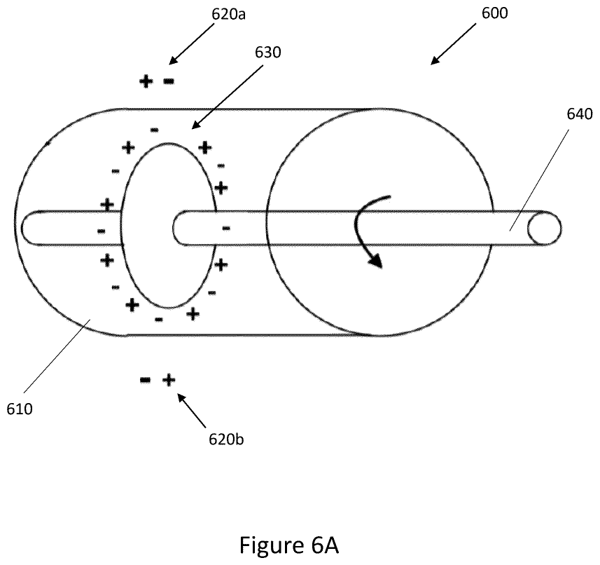

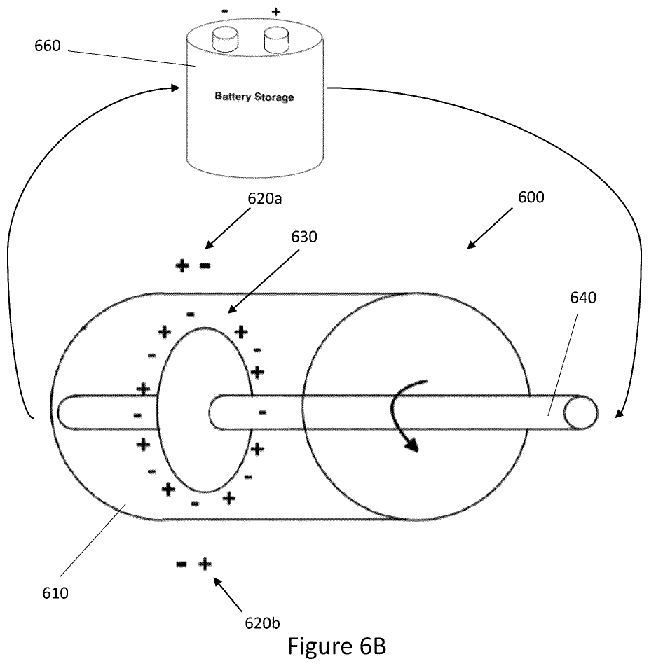

FIG. 6 shows a schematic view of a device 600 for generating power. As seen in FIG. 6, the system may include an outer shell 610 or surface, a plurality of external magnet arrays 620a and 620b, a mobius magnet array 630, and a shaft 640. As seen in FIG. 6, the outer shell 610 may be cylindrical in shape. In some embodiments, the outer shell 610 encloses the shaft 640, the external magnet array 620, and the mobius magnet array 630. In some embodiments, the outer shell 610 only encloses a portion of the shaft 640.

The device 600 includes external magnet arrays 620a and 620b. In some embodiments, the magnets forming the external magnet arrays 620a and 620b may be permanent magnets or electromagnets. In some embodiments, the magnets forming the external magnet arrays 620a and 620b are formed of a ferromagnetic material, such as, but not limited to, iron, nickel, cobalt, or combinations of the aforementioned materials. The external magnet arrays 620a and 620b may be attached to the outer shell. In some embodiments, the external magnet arrays 620a and 620b are attached to an internal side of the outer shell 610.

In some embodiments, the device 600 includes a first external magnet array 620a and a second external magnet array 620b. In some embodiments, the first external magnet array 620a is disposed at a first location on the surface of the outer shell 610. In some embodiments, the second external magnet array 620b is disposed at a second location on the surface of the outer shell 610. In some embodiments, the first external magnet array 620a is disposed on a first external surface of the outer shell 610 and the second external magnet array 620b is disposed on a second external surface on the outer shell 610. In some embodiments, the first and second magnet array 620a and 620b are orientated such that they are located opposite to each other. In some embodiments, the first and second external magnet arrays 620a and 620b are located on opposite sides of the outer shell 610 such that the mobius magnet array 630 and the shaft 640 are disposed between the first external magnet array 620a and the second external magnet array 620b. In some embodiments, the magnets of the first external magnet array 620a are orientated on a surface of the outer shell 610 such that the magnetic poles of each magnet in the first external magnet array 620a are arranged in the same direction. In some embodiments, the magnets of the first external magnet array 620a are orientated such that the magnetic poles of at least one magnet in the array 620a is aligned differently from an adjacent magnet in the array 620a. In some embodiments, the first external magnet array 620a creates a magnetic field within the interior of the outer shell 610.

In some embodiments, the magnets of the second magnet array 620b are orientated on a surface of the outer shell 610 such that the magnetic poles of each magnet forming the second external magnet array 620b are arranged in the same direction. In some embodiments, the magnets of the second external magnet array 620b are orientated such that the magnetic poles of at least one magnet in the array 620b is aligned differently from an adjacent magnet in the array 620b. In some embodiments, the magnets of the second external magnet array 620b are orientated such that the poles of the magnets forming the second external magnet array 620b are arranged opposite to the poles of the magnets forming the first external magnet array 620a. In some embodiments, the second external magnet array 620b creates a magnetic field within the interior of the outer shell 610. In some embodiments, the magnetic field created by the second external magnet array 620b overlaps with the magnetic field created by the first external magnet array 620a. In some embodiments, the magnetic field created by the second external magnet array 620b does not overlap with the magnetic field created by the first external magnet array 620a.

The device 600 includes a mobius magnet array 630. In some embodiments, the mobius magnet array 630 is similar or identical to the mobius magnet array 530 as described above.

The mobius magnet array 630 is disposed within the outer shell 610. In some embodiments, the mobius magnet array 630 is disposed within the outer shell 610 such that the mobius magnet array 630 is located between the first external magnet array 620a and the second magnet array 620b. In some embodiments, the mobius magnet array 630 is similar or identical to the mobius magnet array 530 as described above. In some embodiments, the mobius magnet array 630 is orientated within the outer shell 610 such that the magnets of the mobius magnet array 630 are affected by the magnetic fields generated by the first and second external magnet arrays 620a and 620b. In some embodiments, the magnetic fields generated by the first and second external magnet exert a force on the magnets of the mobius magnet array 630, thereby causing the mobius magnet array 630 to rotate in a first direction.

The shaft 640 is disposed within the outer shell 610. In some embodiments, only a portion of the shaft 640 is disposed within the outer shell 610 such that a portion of the shaft 640 protrudes from the outer shell 610. In some embodiments, the shaft 640 is attached to the mobius magnet array 630. In some embodiments, the shaft 640 is attached to the mobius magnet array 630 such that a portion of the shaft 640 is disposed through the central orifice of the mobius strip of the mobius magnet array 630. In some embodiments, the shaft 640 is connected to the mobius magnet array 630 such that when the mobius magnet array 630 is rotated by the magnetic fields generated by the first and second external magnet arrays 620a and 620b the shaft 640 is also rotated in the same direction as the mobius magnet array 630.

In some embodiments, the shaft 640 is further connected to an alternator or other power generation device. The alternator is configured to convert the rotational movement of the shaft 640 into electrical power.

In some embodiments, the system 600 may further include coils such that the rotational movement of the mobius magnet array generates an electrical current in the coils. This configuration may beneficially combine the features of a prime mover with an alternator.

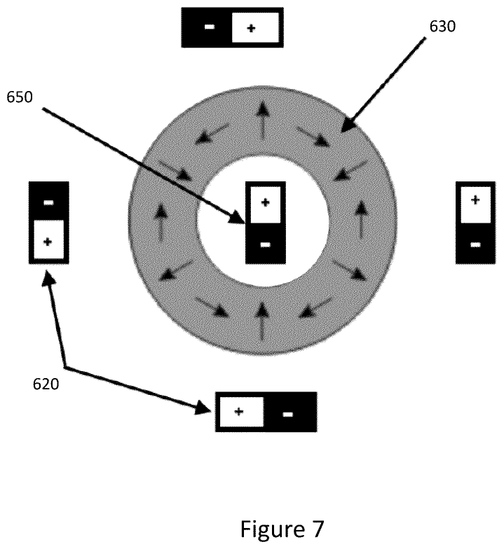

FIG. 6B shows a schematic view of a device 600 for generating power connected to a battery storage system 660. As seen in FIG. 6B, the device 600 may be electrically connected to a battery storage system 660. In some embodiments, the battery storage system 660 is electrically connected to at least one of the external magnet arrays 620a and 620b. In some embodiments, the battery storage system 660 is electrically connected to the mobius magnet array 630. In some embodiments, the battery storage system 660 is electrically connected to an internal magnet array 650 as described below in connection with FIG. 7. In some embodiments, the battery storage system 660 provides electrical power to the external magnet arrays 620a and 620b, the mobius magnet array 630, and/or the internal magnet array 650. In some embodiments, the power provided by the battery storage system 660 to the external magnet arrays 620a and 620b, the mobius magnet array 630 and/or an internal magnet array 650 augments or initiates the magnetic fields generated by the external magnet arrays 620a and 620b, the mobius magnet array 630, and/or the internal magnet array 650 respectively. This, in turn, causes the mobius magnet array 630 to begin to rotate or to rotate at an increased rate, thereby causing the shaft 640 to begin to rotate or to rotate at an increased rate. This, in turn, leads to initiation of power generation by the device 600 or to an increase in power generation by the device 600.

In some embodiments, the battery storage system 660 is further configured to receive electrical power from the device 600. In some embodiments, a generator or alternator converts the rotational energy of the shaft 640 into electrical power which is then directed to the battery storage system 660. In some embodiments, only a portion of the power generated by the device 600 and/or the generator is directed to the battery storage system 660. The power received from the device 600 or from the generator may serve to charge the batteries of the battery storage system 660.

Including a battery storage system 660 beneficially allows for “back and forth” transfer of electrical power between the battery storage system 660 and the device 600. This beneficially allows for the rotational movement of the mobius magnet array 630 and the shaft 640 of the device 600 to be consistently maintained and/or controlled, enables unique form factors, and improves existing electrical generation systems but with greater savings.

FIG. 7 shows another view of the device 600. As seen in FIG. 7, the device 600 may include a plurality of external magnet arrays 620 arranged around the mobius magnet array 630. As seen in FIG. 7, the external magnet arrays 620 may be orientated around the mobius magnet array 630 such that the poles of the external magnet arrays 620 located opposite to each other have opposite polarities. In some embodiments, the external magnet arrays 620 may be orientated around the mobius magnet array 630 such that the south magnetic pole of a first magnet array is closest in proximity to the south magnetic pole of an adjacent external magnet array.

As seen in FIG. 7, in some embodiments, the device 600 further includes at least one internal magnet array 650. In some embodiments, the internal magnet array 650 is disposed within a central orifice of the mobius magnet array 630. In some embodiments, the internal magnet array 650 is stationary does not move with the mobius magnet array 630. In some embodiments, the internal magnet array 650 is attached to mobius magnet array 630 and rotates with the mobius magnet array 630. In some embodiments, the internal magnet array 650 creates a magnetic field with the outer shell 610 and causes the mobius magnet array 630 to rotate. In some embodiments, the internal magnet array 650 is disposed with a stationary set of conductors. In some embodiments, the rotational movement of the internal magnet array 650 within the conductors creates electrical current.

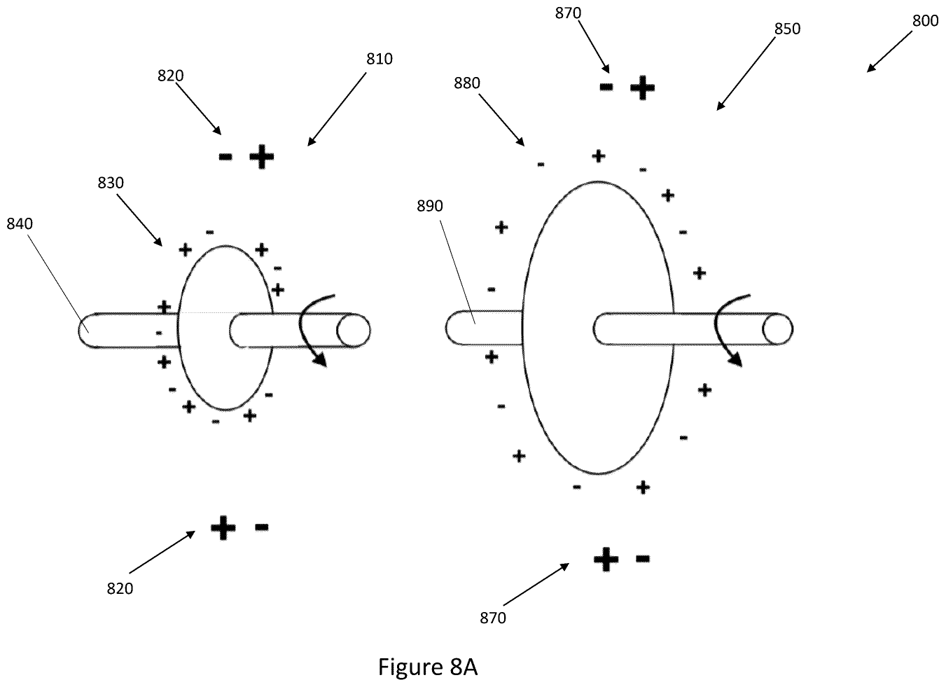

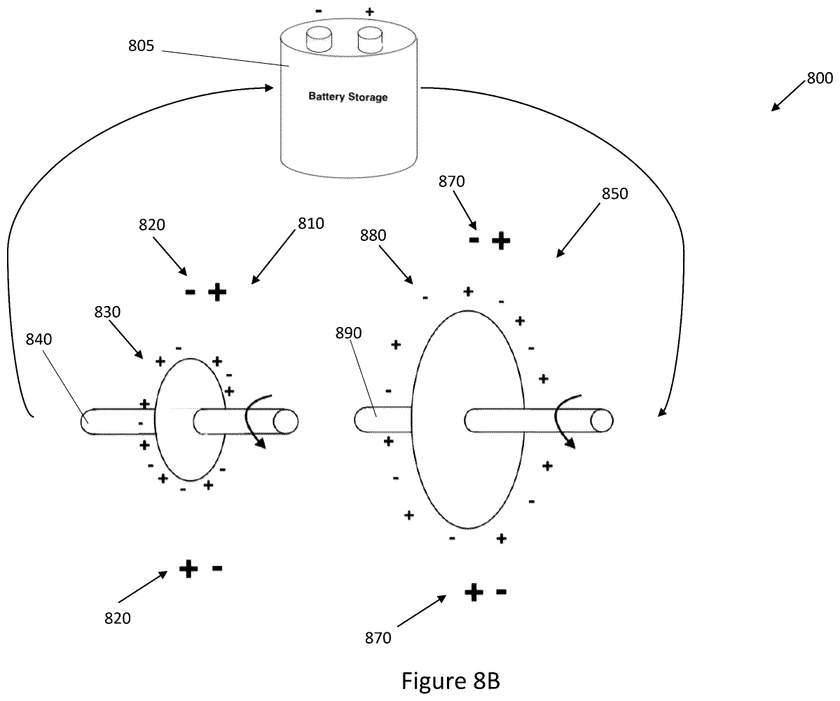

FIG. 8A shows a schematic view of a system 800 for generating power.

The system may include a plurality of devices. In some embodiments, the system 800 includes a first device 810 and a second device 850.

In some embodiments, the first device 810 is similar or identical to the device 600 for generating power as described above. The first device 810 may include an outer shell, at least one external magnet array 820, mobius magnet array 830 and a shaft 840 similar or identical to the device 600. In some embodiments, the plurality of magnets of the mobius magnet array 830 are permanent magnets.

In some embodiments, the first device 810 is electrically connected to the second device 850. In some embodiments, the shaft 840 of the first device 810 is connected to an alternator which is electrically connected to the second device 850. The alternator converts the rotational energy of the shaft 840 into electrical power. In some embodiments, the electrical power generated by the first device 810 is directed to the second device 850.

In some embodiments, the second device 850 is similar or identical to the device 600 for generating power as described above. The second device 850 may include an outer shell, at least one external magnet array 870, a mobius magnet array 880 and a shaft 890 similar or identical to the device 600. In some embodiments, the first device 810 is similar to the second device 850. In some embodiments, the second device 850 is larger than the first device 810. In some embodiments, the plurality of magnets of the mobius magnet array 880 of the second device 850 are electromagnets. In some embodiments, the electromagnets of the mobius magnet array 870 are powered by the electrical power generated by the first device 810.

In some embodiments, the shaft 890 of the second device 810 is connected to an alternator. The alternator is configured to convert the rotational energy of the shaft 890 into electrical power.

In some embodiments, the power generated by the second device 850 may be greater than the electrical power generated by the first device 810.

FIG. 8B shows a schematic view of a system 800 for generating power. As seen in FIG. 8B, the system 800 further includes a battery storage system 805. In many respects, the battery storage system 805 may be similar or identical to the battery storage system 600 described above. The battery storage system 805 may be electrically connected to the first device 810 or second device 850. In some embodiments, the battery storage system is electrically connected to both the first device 810 and the second device 850.

In some embodiments, the battery storage system 805 is electrically connected to the at least one external magnet array 820 of the first device 810. In some embodiments, the battery storage system 805 provides electrical power to the external magnet array 820 of the first device 810. In some embodiments, the power provided by the battery storage system 805 to the external magnet array 820 initiates or increases the rotational movement of the mobius magnet array 830 and the shaft 840.

In some embodiments, the battery storage system 805 is electrically connected to the at least one external magnet array 870 of the second device 850. In some embodiments, the battery storage system 805 is electrically connected to the mobius magnet array 880 of the second device 805. In some embodiments, the battery storage system 805 provides electrical power to the external magnet array 870 and/or the mobius magnet array 880 of the second device 850. In some embodiments, the power provided by the battery storage system 805 to the external magnet array 870 and/or the mobius magnet array 880 of the second device 850 supplements the power provided by the first device 810 to the second device 850, thereby augmenting the magnetic field generated by the external magnet array 870 and/or the mobius magnet array 880. This, in turn, causes increased rotational movement of the mobius magnet array 880 and the shaft 890m thereby increasing the electrical power generation of the second device 850. In some embodiments, the power provided by the battery storage system 805 to the external magnet array 870 and/or the mobius magnet array 880 initiates the rotational movement of the mobius magnet array 880 and the shaft 890.

In some embodiments, the battery storage system 805 is further configured to received electrical power from the second device 850. In some embodiments, a generator or alternator converts the rotational energy of the shaft 890 into electrical power which is then directed to the battery storage system 805. In some embodiments, only a portion of the power generated by the second device 850 and/or the generator is directed to the battery storage system 805. The power received from the second device 850 or from the generator may serve to charge the batteries of the battery storage system 805.

Including a battery storage system 805 beneficially allows for “back and forth” transfer of electrical power between the battery storage system 805 and the system 800. This beneficially allows for the rotational movement within the first device 810 and second device 850 to be consistently maintained and/or controlled, enables unique form factors, and improves existing electrical generation systems but with greater savings.

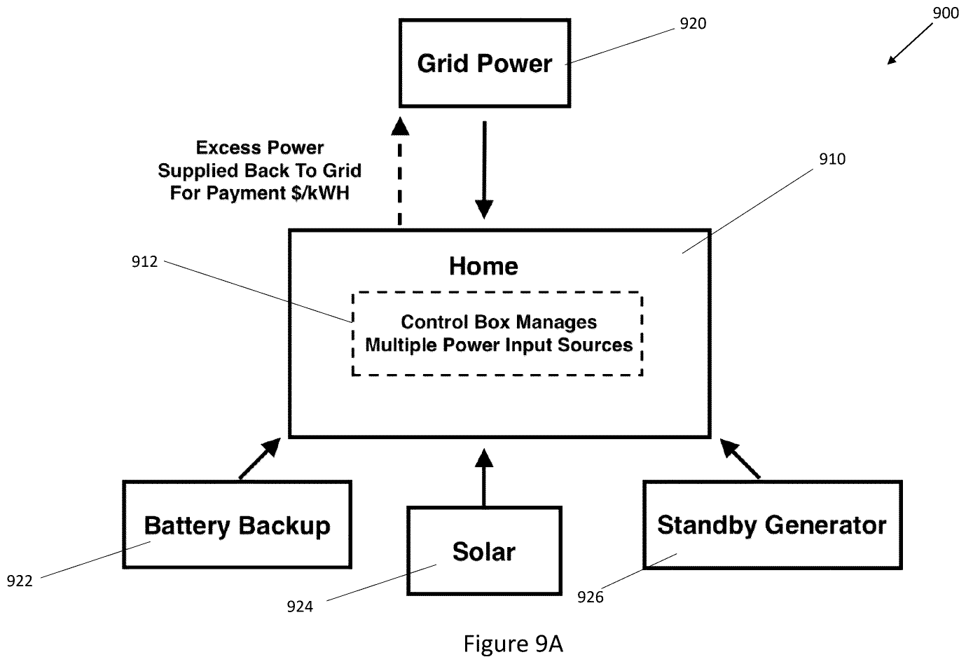

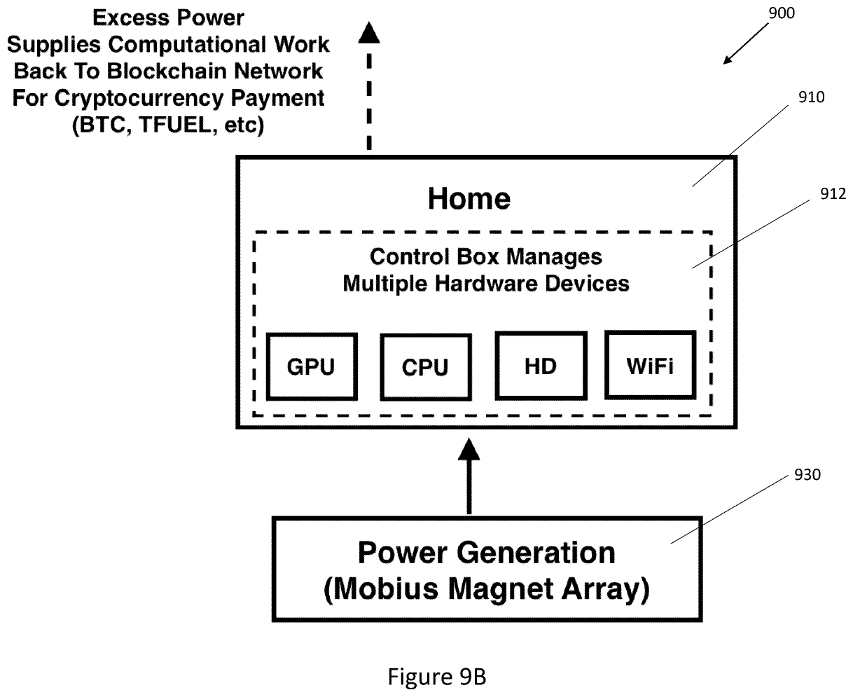

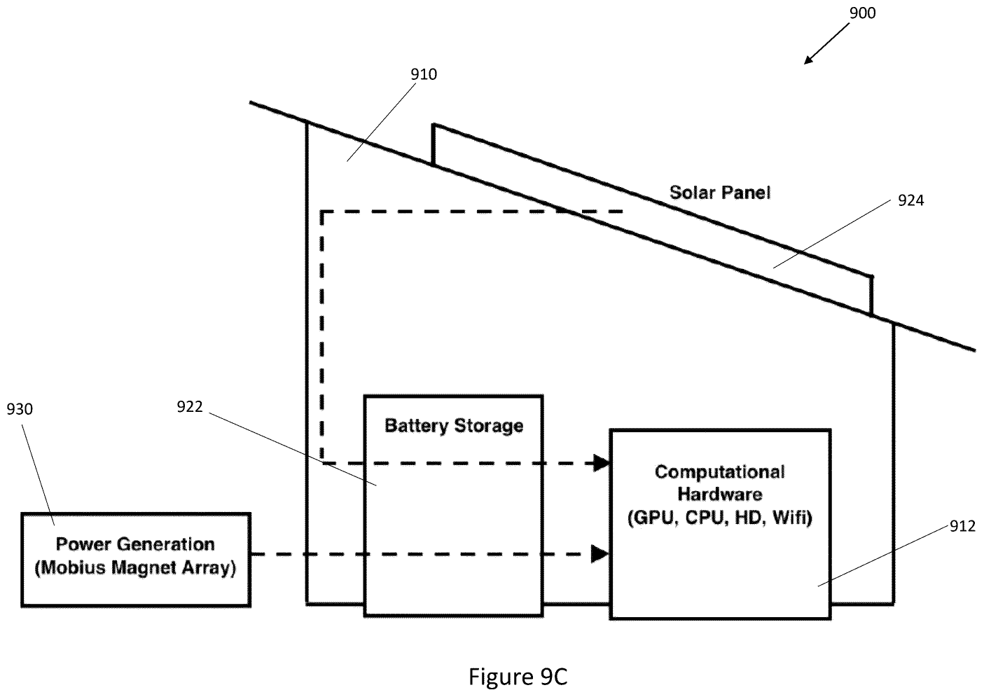

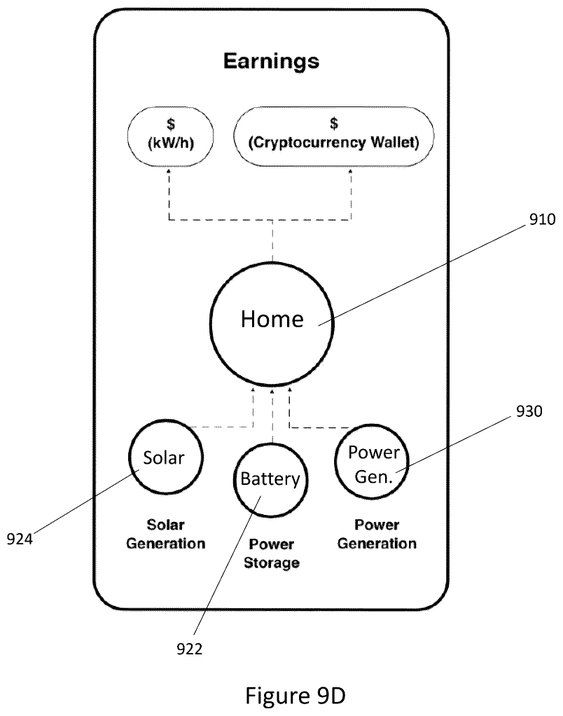

FIG. 9A shows a schematic view of a system 900 for powering a home 910. The home 910 receives power from a variety of power sources. The power sources may include an electrical grid 920, a battery backup 922, a standby generator 926, and solar panels 924. Each of the power sources may provide power to the home 910. The power received from the various power sources are used to power various parts of the home 910 including lighting, kitchen appliances, laundry appliances, electronics, HVAC, electronics, and user devices. The home 910 includes a control box 912. The control box 912 is configured to control or manage the amount of electrical power received from the power sources. The control box 912 is further configured to control which power sources the home 910 receives power from. The control box may direct power from the grid 920 to the battery backup 922 in order to charge the batteries. The control box 912 may also direct any excess power generated by the power sources to the electrical grid 920 in exchange for payment.

FIG. 9B shows a schematic view of a system 900 including a power generation system 930. In some embodiments, the power generation system 930 is similar or identical to the power generation device 600 as described herein or the power generation system 800 as described herein. As seen in FIG. 9B, a home 910 may be configured to receive electrical power generated by the power generation system 930. The home 910 may include a control box 912 configured to direct power received from the power generation system 930 to various parts of the home 910. In some embodiments, the control box 912 may include a variety of hardware, including graphics cards (GPUs), microprocessors (CPUs), storage hard-drives (HDs), and RF (WiFi) devices. In some embodiments, the control box 912 is configured to manage the uptime of the hardware and/or synchronize with blockchain networks, such as the Theta Network. In some embodiments, the hardware of the control box 912 is modularized. This configuration is beneficial for allowing the hardware to be upgraded and/or updated periodically. In some embodiments, the hardware may be not a part of the control box 912.

In some embodiments, the control box 912 is configured to direct any excess power generated by the power generation system 930 to the hardware within the control box 912. In some embodiments, the hardware uses the excess energy provided by the power generation system 930 to supply computational power to a blockchain network. The computational power may be used to mine and/or validate reward based blockchains, such as Bitcoin and Theta Network. For example, the Theta Network rewards participants a reward cryptocurrency, Theta Fuel (TFUEL), for allocating unused computational capacity from GPUs, CPUs, Storage HD, as well as unused internet bandwidth. The Theta Network offers this collective excess hardware capacity as useable cloud and internet bandwidth services to their customers. This power generation system as described herein beneficially allows a user to receive rewards such as payment or cryptocurrency in exchange for the excess power generated by the power generation system 930. In some embodiments, the control box 912 is further configured to direct excess power generated by the power generation system 930 to an electrical power grid in exchange for payment.

In some embodiments, payment received in the form of cryptocurrency can be stored in a wallet locally within the hardware of the control box 912 or can be stored in a wallet managed by a 3rd party provider. Access and visibility to the wallet can be managed through a consumer's mobile device. The cryptocurrency earnings in the wallet can be automatically exchanged for local currency like dollars or spent as cryptocurrency.

In some embodiments, the system 900 of FIG. 9B may further include additional power sources including solar panels 924 and/or a battery storage 922 as seen in FIG. 9C. As seen in FIGS. 9C and 9D, the control box 912 may be further configured to use excess power generated by the solar panels 924, the power generation system 930 and the battery storage 922 to provide computational power to blockchain networks in exchange for payment or cryptocurrency or to provide electrical power back to an electrical gird in exchange for payment.

As seen in FIGS. 9A, 9C, and 9D, the system 900 may include multiple power sources. Systems with multiple power sources (for example a battery storage and a mobius magnet array) beneficially increase the “uptime” of hardware connectivity. Consistency or reliability of “up time” for hardware connectivity is important when contributing computational resources to networks like Theta. A home or building with multiple backup power options guarantees high “up time” as power can be supplied to the hardware from a second power source if a first power source fails. The systems described herein beneficially allow a home or building with resilient power backup redundancy to become a competitive and reliable node in a blockchain network.

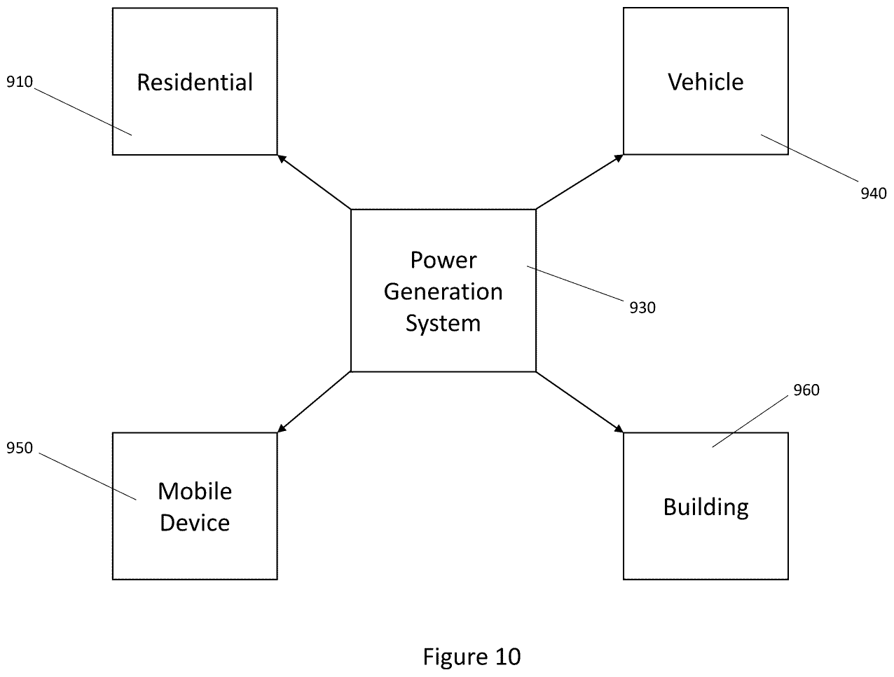

FIG. 10 shows a variety of forms that the power generation system 930 as described herein can be implemented into. As seen in FIG. 10, the power generation system 930 as described herein can be implanted into a home 910 or residential dwelling, into a vehicle 940, such as, but not limited to, an automobile, watercraft, or aircraft, into a user device 950, such as, but not limited to, mobile devices, personal computers, wearable devices, or into other buildings 960. The power generation system 930 as described herein can be scaled in size for commercial industrial use or miniaturized for cell phone and/or vehicle power generation.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A device for generating power, the device comprising:
a mobius magnet array comprising:
a surface in the form of a mobius strip; and
a plurality of magnets disposed on the surface;
an external magnet array configured to generate a magnetic field within the device, wherein the magnetic field exerts a rotational force on the mobius magnet array;
a shaft connected to the mobius magnet array, the shaft configured to rotate when the magnetic field exerts a force on the mobius magnet array; and
an alternator connected to the shaft, the alternator configured to convert the rotational motion of the shaft into electrical power.

2. A method for generating power, the method comprising:
providing a mobius magnet array comprising:
a surface in the form of a mobius strip; and
a plurality of magnets disposed on the surface;
exposing the mobius magnet array to an external magnetic field;
rotating the mobius magnet array in response to the external magnetic field;
rotating a shaft connected to the mobius magnet array; and
converting the rotational motion of the shaft into electrical power.

3. The method of claim 2, further comprising:
directing at least a portion of the electrical power to hardware;
providing computational power, via the hardware, to a blockchain network; and
validating a blockchain within the blockchain network.
